(19) United States
(12) Patent Application Publication
(10) Pub. No.: US 2024/0117951 A1
(43) Pub. Date: Apr. 11, 2024

(54) LIGHTING DEVICE FOR A VEHICLE, COMPRISING A SCREEN WITH A PLURALITY OF LIGHT GUIDES

(71) Applicant: VALEO VISION, Bobigny (FR)

(72) Inventors: Kostadin BEEV, Bobigny (FR); Anthony LOZANO, Bobigny (FR); Patrice COLLOT, Bobigny (FR); Stephanie BERGERAT, Bobigny (FR); Thomas DUFILS, Bobigny (FR)

(73) Assignee: VALEO VISION, Bobigny (FR)

(21) Appl. No.: 18/546,200

(22) PCT Filed: Feb. 9, 2022
(86) PCT No.: PCT/EP2022/053153

§ 371 Date: Aug. 11, 2023

(30) Foreign Application Priority Data
Feb. 12, 2021 (FR) FR2101349

(51) Int. Cl. F21S 43/251; F21S 43/14; F21S 43/245; F21S 43/247; F21S 43/249

(52) U.S. Cl. CPC F21S 43/251; F21S 43/14; F21S 43/245; F21S 43/247; F21S 43/249

(57) ABSTRACT

A lighting device for a vehicle, the lighting device being configured to perform at least one lighting function and including a screen and at least one light source. The screen has an output face, at least one light guide, and a support for the at least one light guide, and in that the at least one light guide is configured to transmit light rays in the direction of the output face, the light rays being from light rays emitted by the at least one light source and coupled to the at least one light guide, the at least one light guide being injection-molded along with the support.

### TECHNICAL FIELD

The present invention relates to a luminous device for a vehicle, said device being configured to perform at least one luminous function. The present invention is particularly, but non-limitingly, applicable to smart electric vehicles.

### BACKGROUND OF THE INVENTION

Smart electric vehicles require less space at the front for air intakes, but in contrast enhanced luminous functions are required for semi-autonomous or autonomous driving. Therefore, there is a growing interest in integrating “light” into large zones of the front and rear or sides of the vehicle, with a view to obtaining improved signaling and/or communication and to providing new large-area vehicle luminous functions. It is especially desired to obtain an individually controllable signature line with a view to performing a regulatory luminous function and/or generating a given luminous signature and/or even delivering a welcome scenario.

One example known to those skilled in the art of a vehicle luminous device configured to perform at least one luminous function, comprises:
a screen with opaque zones, and
an electronic carrier comprising a plurality of light sources, and
a plurality of signaling structures placed between the opaque zones of the screen.

This luminous device allows an individually controllable signature line to be obtained. Specifically, the electronic carrier is placed facing the screen and comprises a surface that extends the entire length of the surface of said screen. The surface of the electronic carrier is completely covered with light sources. In order to perform a regulatory luminous function, and/or generate a given luminous signature, and/or deliver a welcome scenario, the light sources are selectively activated.

One drawback of this prior art is that such a luminous device comprises too many parts, this generates weight, and comprises too many light sources, this generates a high consumption and high cost.

### SUMMARY OF THE INVENTION

In this context, the present invention aims to provide a luminous device that allows the stated drawback to be remedied.

To this end, the invention provides a luminous device for a vehicle, said luminous device being configured to perform at least one luminous function and comprising a screen and at least one light source, characterized in that said screen comprises an exit face, at least one light guide, and a carrier for said at least one light guide, and in that said at least one light guide is configured to transmit light rays in the direction of said exit face, said light rays being obtained from light rays that are emitted by said at least one light source and coupled to said at least one light guide, said at least one light guide being injection molded with said carrier.

The luminous device is integrable into the body of said vehicle. Said at least one light guide injection molded with said carrier thus forms only a single part.

Thus, as will be seen in detail below, by eliminating signaling structures, the luminous device is lightened. Moreover, by virtue of the light guide, the number of light sources is reduced. It is no longer necessary to cover a large area corresponding to the entire surface of the screen with light sources.

According to non-limiting embodiments, said luminous device may further comprise one or more of the following additional features, implemented alone or in any technically possible combination.

According to one non-limiting embodiment, said at least one light guide has a rectangular, semi-circular, trapezoidal, elliptical or parabolic cross section.

According to one non-limiting embodiment, said luminous device comprises a plurality of light sources and said screen comprises a plurality of light guides.

According to one non-limiting embodiment, two light sources are associated with each light guide.

According to one non-limiting embodiment, one light source is associated with a plurality of light guides, said light source being coupled to optical fibers configured to direct the light rays emitted by said light source toward said plurality of light guides.

According to one non-limiting embodiment, said screen further comprises opaque masks placed between said light guides.

According to one non-limiting embodiment, said exit face of said screen is covered with an opaque, transparent and/or semi-transparent paint on its external surface.

According to one non-limiting embodiment, said at least one light guide comprises prisms or graining, or volumetric scattering particles.

According to one non-limiting embodiment, said at least one light guide is covered with a diffusing paint, or with a metallised paint, or with a metallic coating.

According to one non-limiting embodiment, said at least one light guide encapsulates optical fibers.

According to one non-limiting embodiment, said luminous device further comprises at least one reflector or at least one diffuser placed facing said at least one light guide, or at least one reflective housing in which a light source is placed.

According to one non-limiting embodiment, the carrier of said screen possesses a primary refractive index, and said at least one light guide possesses a secondary refractive index that is higher than said primary refractive index.

According to one non-limiting embodiment, said at least one luminous function is a signaling function or a styling function.

According to one non-limiting embodiment, said luminous device further comprises an outer exit lens placed facing said screen.

According to one non-limiting embodiment, said carrier of said screen and said at least one light guide are made of the same material or of a different material.

There is further provided a process for manufacturing a screen of a luminous device for a vehicle, said screen comprising an exit face, at least one light guide and a carrier for said at least one light guide, characterized in that said manufacturing process comprises producing the carrier with the exit face and said at least one light guide by injection molding. The carrier and said at least one light guide thus form only a single part.

According to one non-limiting embodiment, the injection molding is carried out in a single step, or in at least two steps including one step of injection molding the carrier with the exit face, and one step of injection molding said at least one light guide on said carrier or vice versa.

According to one non-limiting embodiment, the screen comprises a plurality of light guides and opaque masks placed between said light guides, and the injection molding is carried out in three steps including one step of injection molding the carrier with the exit face, one step of injection molding said light guides on the carrier, and one step of injection molding the opaque masks.

According to one non-limiting embodiment, said luminous device comprising said screen further comprises at least one light source, and said at least one light guide is configured to transmit light rays in the direction of said exit face, said light rays being obtained from light rays that are emitted by said at least one light source and coupled to said at least one light guide.

### BRIEF DESCRIPTION OF DRAWINGS

The invention and its various applications will be better understood on reading the following description and on examining the Figs. that accompany it:

FIG. 1 is a schematic view of a luminous device for a vehicle, said luminous device comprising a screen with a carrier with an exit face, a plurality of light guides, and a plurality of light sources, according to one non-limiting embodiment of the invention,

FIG. 2 is a schematic rear view of the luminous device of FIG. 1, according to one non-limiting embodiment,

FIG. 3 shows a schematic rear view, and a schematic cross-sectional view of the luminous device of FIG. 2, said luminous device further comprising electronic carriers for said light sources, according to one non-limiting embodiment,

FIG. 4 is a cross-sectional view of the luminous device of FIG. 2, the screen of said luminous device further comprising opaque masks, according to one non-limiting embodiment,

FIG. 5 is a cross-sectional view of the luminous device of FIG. 2, with an exit face covered with an opaque, transparent and/or semi-transparent paint, according to one non-limiting embodiment,

FIG. 6 is a cross-sectional view of the luminous device of FIG. 2, with light guides according to a first non-limiting embodiment,

FIG. 7 is a cross-sectional view of the luminous device of FIG. 2, with light guides according to a second non-limiting embodiment,

FIG. 8 is a cross-sectional view of the luminous device of FIG. 2, with light guides according to a third non-limiting embodiment,

FIG. 9 is a cross-sectional view of the luminous device of FIG. 2, with light guides further encapsulating optical fibers according to a fourth non-limiting embodiment,

FIG. 10 is a cross-sectional view of the luminous device of FIG. 2, said luminous device further comprising reflectors or diffusers, according to one non-limiting embodiment,

FIG. 11 is a rear view of the luminous device of FIG. 2, said luminous device further comprising reflective housings, according to one non-limiting embodiment,

FIG. 12 is a rear view of the luminous device of FIG. 2, said luminous device further comprising optical fibers coupled to the light sources, according to one non-limiting embodiment,

FIG. 13 is a view of a front face of a vehicle into which the luminous device of FIGS. 1 and 2 may be integrated, according to one non-limiting embodiment,

FIG. 14 is a flowchart of a process for manufacturing a luminous device of FIGS. 1 and 2, according to a first non-limiting embodiment,

FIG. 15 is a flowchart of a process for manufacturing a luminous device of FIGS. 1 and 2, according to a second non-limiting embodiment.

### DETAILED DESCRIPTION OF THE INVENTION

Elements that are identical, in structure or in function, and that appear in more than one Fig., have been designated by the same reference signs, unless otherwise indicated.

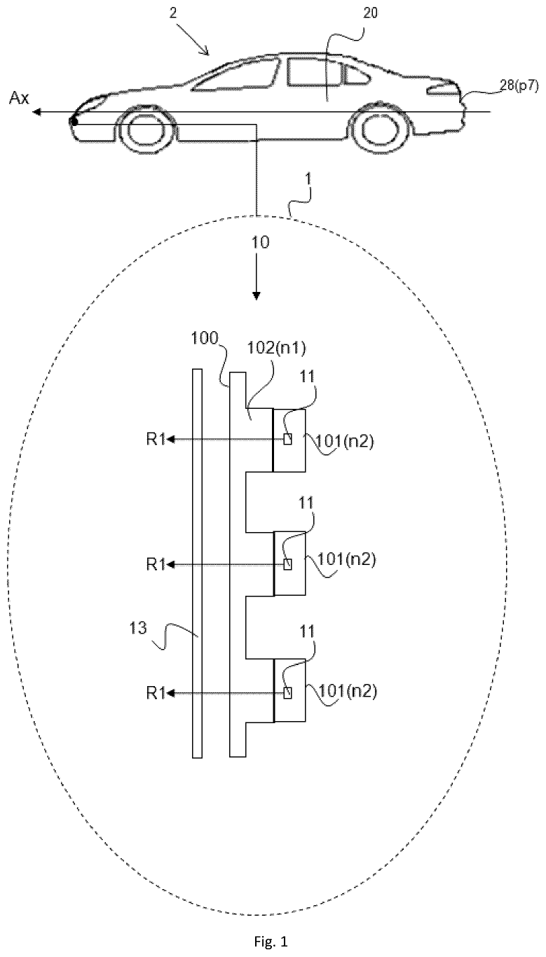

The luminous device 1 according to the invention, which device is for a vehicle 2, will now be described with reference to FIGS. 1 to 13. In one non-limiting embodiment, the vehicle 2 is a motor vehicle. By motor vehicle, what is meant is any type of motorized vehicle. This embodiment is taken as non-limiting example throughout the remainder of the description. Throughout the remainder of the description, the vehicle 2 is thus also called the motor vehicle 2. In one non-limiting alternative embodiment, the vehicle 2 is a semi-autonomous or autonomous electric vehicle.

The luminous device 1 is configured to perform at least one luminous function F. The luminous function F is either regulatory or not. In non-limiting embodiments, said at least one luminous function F is a signaling function or a styling function. In non-limiting examples, the signaling function is a DRL function (DRL standing for Daytime Running Light), a PL function (PL standing for Parking Light), a TL function (TL standing for Tail Light), a flashing TI function (TI standing for Turn Indicator), an SM function (SM standing for Side Marker), etc. In non-limiting examples, the styling function is a luminous signature, a welcome scenario, a decorative luminous function, a luminous display function on the sides, or even a pictogram-displaying function. In one non-limiting embodiment, the luminous device 1 is configured to perform a plurality of luminous functions F.

The luminous device 1 is integrable into the front, the rear or the sides of the motor vehicle 2, and especially into the body 20 of the motor vehicle 2.

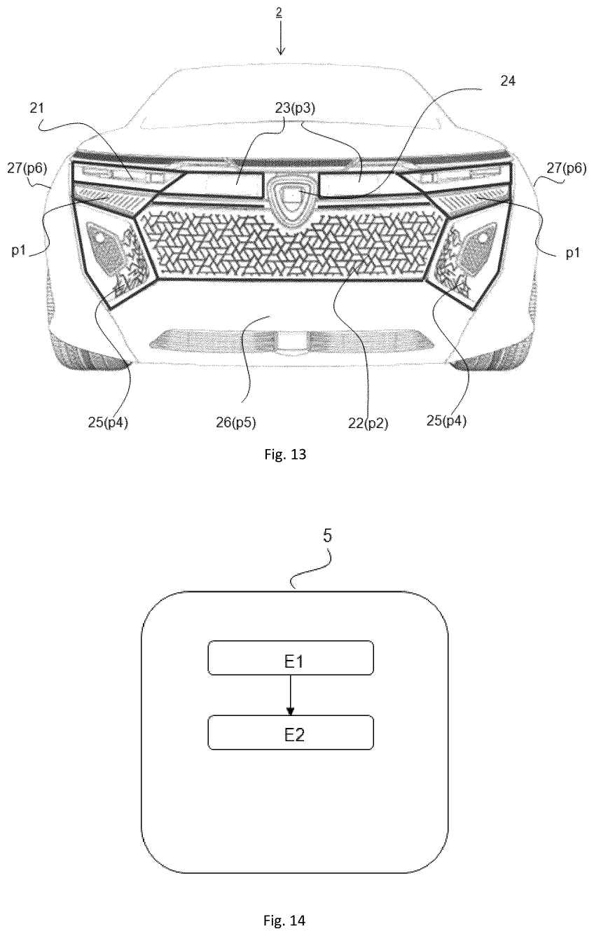

Thus, as illustrated in FIG. 13, in non-limiting embodiments, the luminous device 1 may be integrated into the body 20 of the motor vehicle 2:
below a headlamp 21 (position p1 illustrated),
level with the grille 22 (position p2 illustrated),
between the two headlamps in a central zone 23 (position p3 illustrated) on either side of a logo 24
level with air inlets 25 (position p4 illustrated),
level with the bumper 26 (position p5 illustrated),
on the sides 27 (position p6 illustrated),
at the rear 28 (position p7 illustrated in FIG. 1).

As illustrated in FIG. 1, the luminous device 1 for a vehicle 2 comprises:
a screen 10 comprising an exit face 100, at least one light guide 101, and a carrier 102, and
at least one light source 11.

In one non-limiting embodiment, the luminous device 1 comprises a plurality of light sources 11 and said screen 10 comprises a plurality of light guides 101. This non-limiting embodiment is taken as non-limiting example throughout the remainder of the description.

It will be noted that the luminous device 1 is easily integrable into the body 20 of the motor vehicle 2, because the screen 10 may be painted with the paint of the body 20 and thus merge with said body 20. In this case, in one non-limiting embodiment, the paint is opaque, transparent and/or semi-transparent. In front of the light guides 101, the paint is transparent or semi-transparent in order to allow them to operate. On the rest of the body 20, the paint may be transparent or semi-transparent or opaque.

In one non-limiting embodiment illustrated in FIG. 1, said luminous device 1 further comprises an outer exit lens 13 placed facing said screen 10, and especially facing the exit face 100, on the side opposite the light guides 101. In one non-limiting embodiment, the outer exit lens 13 is painted with opaque, transparent and/or semi-transparent paint or is covered with a metallic coating. In front of the light guides 101, the outer exit lens 13 is painted with transparent or semi-transparent paint, or is covered with a semi-transparent metallic coating, to allow them to operate. In non-limiting examples, the paint is the same color as the paint of the body 20, is a black paint, or is a metallised paint. In non-limiting embodiments, the metallic coating may be produced by electrodeposition, or by physical vapor deposition (PVD).

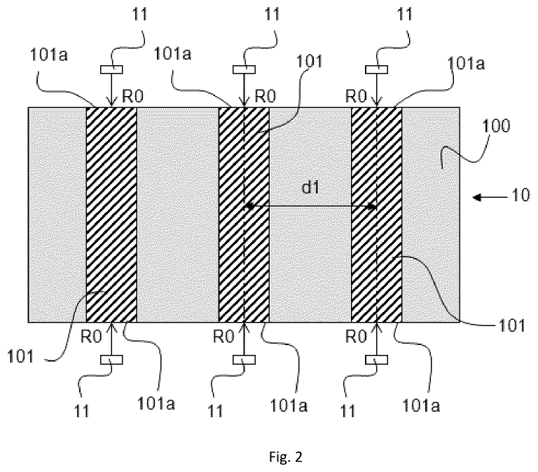

In one non-limiting embodiment, two light sources 11 are associated with each light guide 101. In particular, they are placed on either side of the ends 101a (illustrated in FIG. 2) of one light guide 101.

In one non-limiting embodiment, the luminous device 1 further comprises electronic carriers 12 (illustrated in FIG. 3) for the light sources 11. An electronic carrier 12 bears at least one light source 11. Thus, as illustrated in FIG. 3, in one non-limiting embodiment, the light sources 11 are each placed on one electronic carrier 12. In one non-limiting embodiment illustrated in FIG. 3, the electronic carrier 12 is inserted into a guideway 16 so that the light source 11 faces one end 101a of the light guide 101.

A light source 11 emits light. It is thus configured to emit light rays R0 (illustrated in FIG. 2) that are coupled to the light guide 101 with which it is associated. The light rays R0 propagate through the light guide 101. This thus makes it possible to form light rays R1 (illustrated in FIG. 1) which are transmitted in the direction of the exit face 100 of the screen 10. The light rays R1 pass through the exit face 100. The light sources 11 are selectively activatable. Thus, they may be switched on independently of one another. This allows perception of the desired luminous function F to be reinforced.

In one non-limiting embodiment, the light sources 11 are semi-conductor light sources. In one non-limiting embodiment, a semiconductor light source forms part of a luminous diode. By luminous diode, what is meant is any type of luminous diode, such as, to give non-limiting examples, conventional LEDs (Luminous Diodes), OLEDs (Organic LEDs), AMOLEDs (Active-Matrix-Organic LEDs), FOLEDs (Flexible OLEDs), RGB diodes or multi-chip diodes.

The carrier 102 comprises the exit face 100 and serves as a carrier for the light guides 101.

In one non-limiting embodiment illustrated in FIG. 5, the exit face 100 of said screen 10 is covered with an opaque, transparent and/or semi-transparent paint 103 on its external surface. In front of the light guides 101, it is covered with a transparent or semi-transparent paint 103 to allow them to operate. Lighting is thus provided through said paint 103. A so-called “ghost effect” is obtained. This allows a given luminous signature to be obtained by scraping off portions of the paint 103, by laser scraping in one non-limiting example. In non-limiting examples, the paint 103 is the color of the body 20 or is metallic, or black.

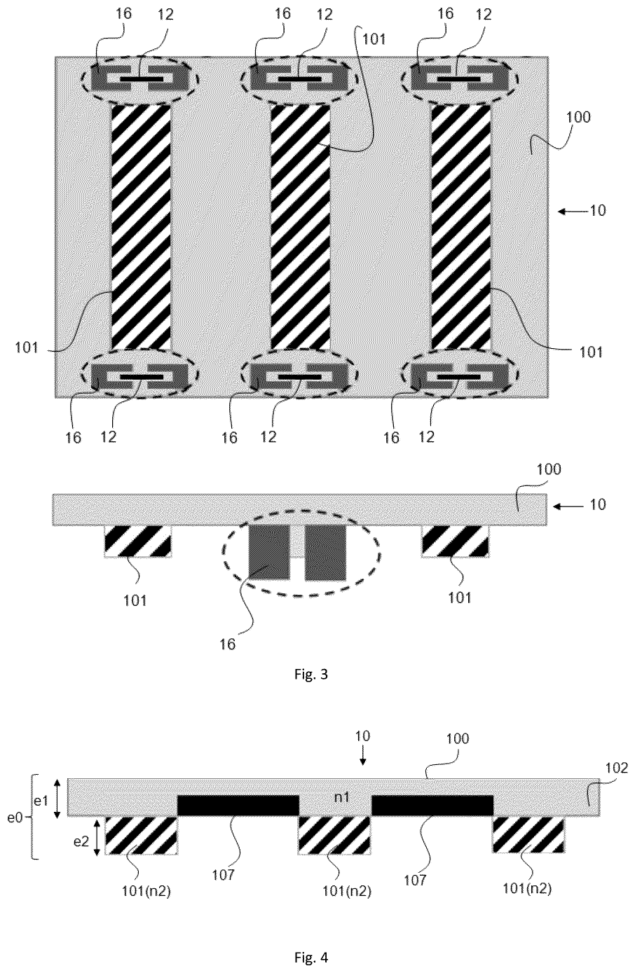

In one non-limiting embodiment illustrated in FIG. 4, the screen 10 further comprises opaque masks 107 placed between said light guides 101. This allows leakage of light to be limited and the contrast between the zones of the exterior surface 100 with or without light guides 101 behind to be increased. This allows optical-signature contrast to be obtained.

The light guides 101 are placed on the side opposite the exit face 100. The carrier 102 is made of a material transparent to visible light. In non-limiting embodiments, the material is polymethyl methacrylate (PMMA) or polycarbonate (PC). As illustrated in FIGS. 4 to 10, in one non-limiting embodiment, the carrier 102 has a thickness e1 comprised between 2.5 mm and 3 mm.

In one non-limiting embodiment, the screen 10 comprises about twenty light guides 101, each light guide 101 being associated with two light sources 11. This is sufficient to perform said at least one desired luminous function F. The light guides 101 extend from the carrier 102, the exit face 100 being located opposite the light guides 101. The light guides 101 are configured to transmit the light emitted by the light sources 11 toward the exit face 100 of the screen 10 and therefore toward the exterior of the motor vehicle 2. In the non-limiting example of FIG. 1, when the luminous device 1 is placed at the front or at the rear of the motor vehicle 2, the light rays R1 are mainly transmitted in the direction of the vehicle axis Ax (illustrated in FIG. 1) or in the opposite direction to the vehicle axis Ax, respectively. In another non-limiting example that is not illustrated, when the luminous device 1 is placed on one side of the motor vehicle 2, the light rays R1 are mainly transmitted in a direction perpendicular to the vehicle axis Ax (illustrated in FIG. 1).

The light guides 101 allow the light, namely the light rays R0, that is emitted by the light sources 11 to be transmitted. The light guides 101 are made of a material transparent to visible light. In one non-limiting embodiment, they are made of the same material as the carrier 102 of the screen 10. In another non-limiting embodiment, they are made of a different material. In non-limiting embodiments, the material is polymethyl methacrylate (PMMA) or polycarbonate (PC). As illustrated in FIGS. 4 to 10, the light guides 101 have a thickness e2 comprised between 3 mm and 10 mm. This thickness e2 is defined depending on the optical requirements of the luminous device 1. In one non-limiting embodiment, the total thickness e0 formed by the thickness e1 of the carrier 102 and by the thickness e2 of the light guides 101 is at most equal to about twice the thickness e1 of the carrier 102. This facilitates production of the screen 10 by injection molding and allows a robust screen 10 to be obtained. It will be noted that when production is by bi-injection molding, it is not absolutely necessary to comply with this rule. In one non-limiting embodiment illustrated in FIG. 2, the light guides 101 are spaced apart by a minimum distance dl of 60 mm. This makes it possible to be able to injection mold each light guide 101 independently. If this distance dl is smaller than 60 mm, tooling arrangements must be made in order to be able to injection mold the light guides 101 in groups.

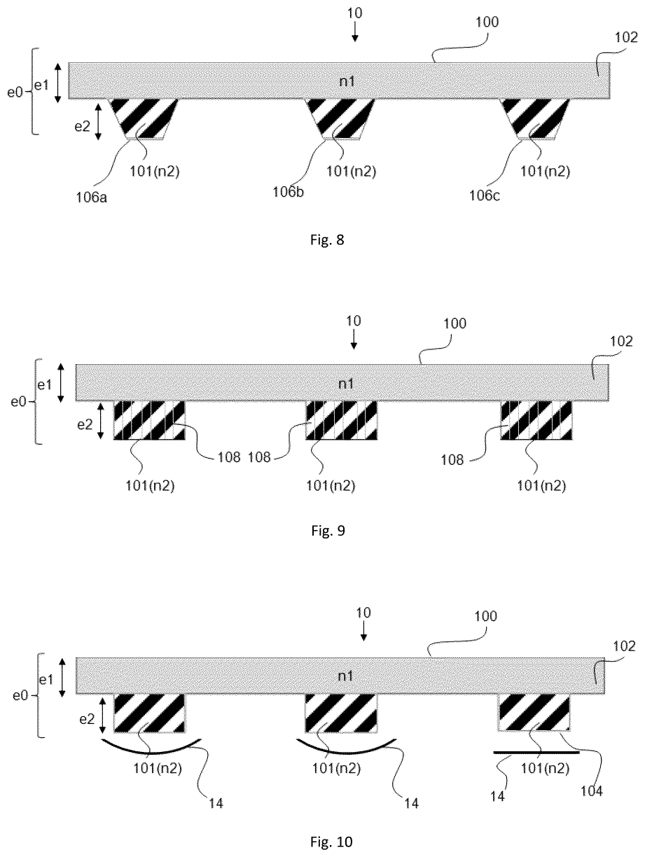

The light guides 101 may take various forms. Thus, in non-limiting embodiments, the light guides 101 have rectangular cross sections as illustrated in FIG. 4 for example, semi-circular cross sections as illustrated in FIG. 7, or trapezoidal cross sections as illustrated in FIG. 8. In other non-limiting embodiments that are not illustrated, the light guides 101 have elliptical or parabolic cross sections.

The light guides 101 may be covered or comprise various elements such as described below according to various non-limiting embodiments.

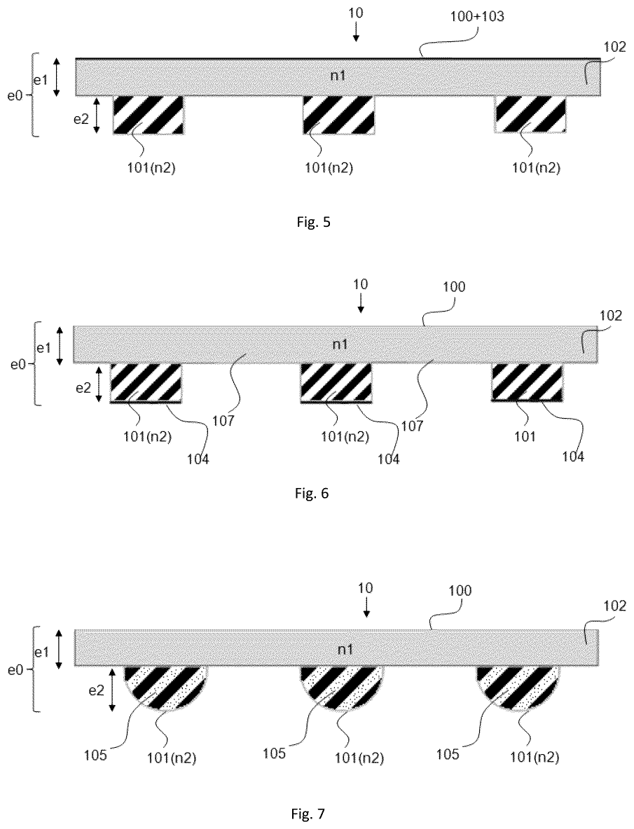

In a first non-limiting embodiment illustrated in FIG. 6, the light guides 101 comprise prisms 104 or a graining 104. The graining allows the light to be given a cloudy appearance when it is observed by an observer from the exterior of the motor vehicle 2. The prisms allow the exit of the light rays R1 in a given direction to be promoted.

In a second non-limiting embodiment illustrated in FIG. 7, the light guides 101 comprise volumetric scattering particles 105. This allows an opalescent appearance and a depth effect to be obtained.

In a fourth non-limiting embodiment illustrated in FIG. 8, the light guides 101 are covered with diffusing paint 106a, or with a metallised paint 106b or with a metallic coating 106c. The diffusing paint 106a allows the uniformity of the distribution of the light to be improved. The metallised paint 106b allows a different appearance (grained metal) to be obtained. In non-limiting embodiments, the metallic coating 106c may be produced by electrodeposition, or by PVD.

In a fifth non-limiting embodiment illustrated in FIG. 9, each light guide 101 encapsulates optical fibers 108. This allows freedom to be obtained in the shape of the luminous signature and the light guides 101 to be given a greater curvature.

It will be noted that the five embodiments presented above may be combined with one another in any combination. Moreover, it will be noted that they may be combined with the opaque masks 107 or even the opaque, transparent and/or semi-transparent paint 103 covering the exit face 100.

In one non-limiting embodiment illustrated in FIG. 10, the luminous device 1 further comprises at least one reflector 14 or diffuser 14 placed facing the light guides 101. The reflector 14 allows the efficiency of the luminous device 1 to be improved. The diffuser 14 allows light of good uniformity to be obtained. In illustrated non-limiting embodiments, the reflector 14 or diffuser 14 is curved or planar. In one non-limiting embodiment, the reflector 14 is grained. This allows diffusion around a given direction to be obtained. In the non-limiting example illustrated, there are as many reflectors/diffusers 14 as there are light guides 101. In the non-limiting example illustrated, a reflector has been represented in the same way as a diffuser and the same reference 14 has been assigned to them.

In another non-limiting embodiment illustrated in FIG. 11, the luminous device 1 further comprises a reflective housing 15 in which is placed a light source 11. This allows the coupling of the light rays R0 to the light guide 101 to be improved, and allows a seal-tight light source 11 to be obtained if the reflective housing 15 is closed.

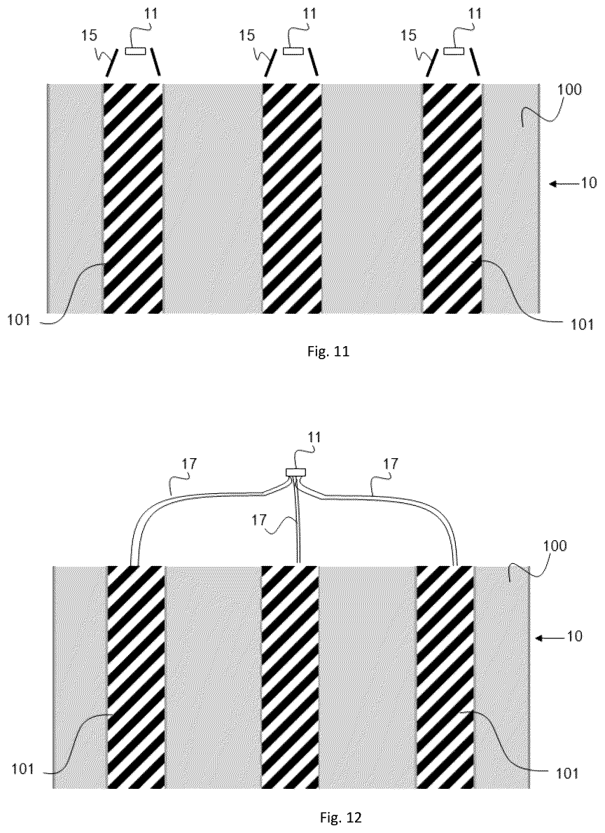

In another non-limiting embodiment illustrated in FIG. 12, one light source 11 is associated with a plurality of light guides 101, said light source 11 being coupled to optical fibers 17 configured to direct the light (the light rays R0) emitted by said light source 11 toward said plurality of light guides 101. In the non-limiting example illustrated, there is thus one light source 11 coupled to three sets of optical fibers 17, each set directing the light rays R0 toward three different light guides 101.

In one non-limiting embodiment illustrated in FIGS. 1 and 4 to 10, the carrier 102 with the exit face 100 possesses a primary refractive index n1, and said light guides 101 possess a secondary refractive index n2 that is higher than said primary refractive index n1. This allows total reflection to be obtained for light rays R0 having large angles of incidence (larger than 60° in one non-limiting example). The light rays R0 emitted by the light sources 11 thus propagate deep into the material of the light guides 101.

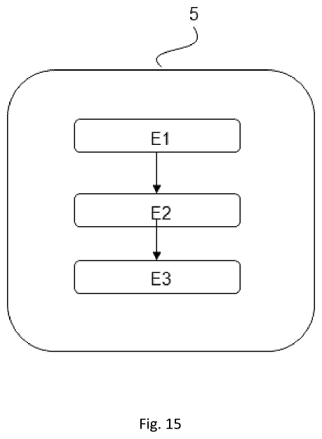

The process 5 for manufacturing the screen 10 of the luminous device 1 is illustrated in FIGS. 14 and 15 according to non-limiting embodiments. The manufacturing process 5 comprises producing the carrier 102 with the exit face 100 and said light guides 101 by injection molding.

In a first non-limiting embodiment, the injection molding is carried out in a single step. In particular, a single injection-molding operation is carried out if the exit face 100, the carrier 102 and the light guides 101 are made of the same material or if the light guides 101 are not too thick. In one non-limiting example, for a total thickness e0 of 6 mm, e1=e2=3 mm.

In a second non-limiting embodiment illustrated in FIG. 14, the injection molding is carried out in two steps including one step E1 of injection molding the carrier 102 with the exit face 100, and one step E2 of injection molding said light guides 101 on said carrier 102 or vice versa. Thus, the light guides 101 are over-molded on the carrier 102 or the carrier 102 is over-molded on the light guides 101. In particular, two injection-molding operations are carried out if the carrier 102 and the light guides 101 are made of different materials or if the light guides are too thick. In one non-limiting example, if e0 is larger than 6 mm, or if there is too large a difference between e1 and e2, two injection-molding operations are used. Of course, two injection-molding operations may also be carried out if the same material is used. In one non-limiting embodiment, there is one injection point per group of light guides 101 to be injection molded. Thus, in one non-limiting example, if there are twenty light guides 101, there will be five groups, each comprising four light guides 101 and therefore five injection points.

In a third non-limiting embodiment illustrated in FIG. 15, when the luminous device 1 comprises opaque masks 107, the injection molding is carried out in three steps including one step E1 of injection molding the carrier 102 with the exit face 100, one step E2 of injection molding said light guides 101 on the carrier 102, and one step of injection molding the opaque masks 107. In another non-limiting embodiment, the opaque masks 107 may be produced using an IML process (IML standing for In-Mold Labeling).

Thus, the carrier 102 with the exit face 100 and the light guides 101 form just one single part, i.e. the screen 10. There is no adhesive bonding or mechanical assembly of the light guides 101 on the carrier 102.

Of course the description of the invention is not limited to the embodiments described above and to the field described above. Thus, in one non-limiting embodiment, said luminous device 1 further comprises at least one seal-tight housing into which said plurality of light sources 11 is integrated or a seal-tight housing for each light source 11. Thus, in another non-limiting embodiment, a single electronic carrier 12 is used to bear all of the light sources 11. Thus, in another non-limiting embodiment, the light source 11 is placed on the side of a light guide 101 when the light source 11 is a light source that emits in a direction parallel to the carrier of the light source 11, i.e. when it is a so-called side-emitting LED. Thus, in another non-limiting embodiment, a light source 11 is associated with a single light guide 101.

Thus, the invention described especially has the following advantages:
it allows a luminous device 1 to be obtained that is lighter than the device of the prior art; specifically, the signaling structures of the prior art have been eliminated; integration into the body 20 of the vehicle 2 is thus easier,
it allows the number of light sources 11 to be reduced with respect to the prior art, this reducing wiring and consumption of current; it thus allows a reasonable number of light sources 11 to be employed and cost to be reduced accordingly,
it allows one or more luminous functions F to be performed.

What is claimed is:

1. A lighting device for a vehicle, the lighting device being configured to perform at least one lighting function and comprising a screen and at least one light source, wherein the screen includes an exit face, at least one light guide, and a carrier for the at least one light guide, and in that the at least one light guide is configured to transmit light rays in the direction of the exit face, the light rays being obtained from light rays that are emitted by the at least one light source and coupled to the at least one light guide, the at least one light guide being injection molded with the carrier.

2. The lighting device as claimed in claim 1, wherein the at least one light guide has a rectangular, semi-circular, trapezoidal, elliptical or parabolic cross section.

3. The lighting device as claimed in claim 1, wherein the lighting device includes a plurality of light sources and the screen includes a plurality of light guides.

4. The blighting device as claimed in claim 3, wherein two light sources are associated with each light guide.

5. The lighting device as claimed in claim 3, one light source being associated with a plurality of light guides, the light source being coupled to optical fibers configured to direct the light rays emitted by the light source toward the plurality of light guides.

6. The lighting device as claimed in claim 3, wherein the screen includes opaque masks placed between the light guides.

7. The lighting device as claimed in claim 1, wherein the exit face of the screen is covered with an opaque, transparent and/or semi-transparent paint on its external surface.

8. The lighting device as claimed in claim 1, wherein the at least one light guide includes prisms or graining, or volumetric scattering particles.

9. The lighting device as claimed in claim 1, wherein the at least one light guide is covered with a diffusing paint, or with a metallised paint, or with a metallic coating.

10. The lighting device as claimed in claim 1, wherein the at least one light guide encapsulates optical fibers.

11. The lighting device as claimed in claim 1, further comprising at least one reflector or at least one diffuser placed facing the at least one light guide, or at least one reflective in which a light source is placed.

12. The lighting device as claimed in claim 1, wherein the carrier of the screen possesses a primary refractive index, and the at least one light guide possesses a secondary refractive index that is higher than the primary refractive index.

13. The lighting device as claimed in claim 1, wherein the at least one lighting function is a signalling function or a styling function.

14. The lighting device as claimed in claim 1, wherein the lighting device further comprises an outer exit lens placed facing the screen.

15. A process for manufacturing a screen of a lighting device for a vehicle, the screen including an exit face, at least one light guide and a carrier for the at least one light guide, wherein the manufacturing process comprises producing the carrier with the exit face and the at least one light guide by injection molding.

16. The manufacturing process as claimed in claim 15, wherein the injection molding is carried out in a single step, or in at least two steps including one step of injection molding the carrier with the exit face, and one step of injection molding the at least one light guide on the carrier or vice versa.
